(19) United States
(12) Patent Application Publication
(10) Pub. No.: US 2024/0145884 A1
(43) Pub. Date: May 2, 2024

(54) BATTERY CONNECTION STRUCTURE, BATTERY SYSTEM, AND ELECTRIC VEHICLE

(71) Applicants: MICROVAST POWER SYSTEMS CO., LTD., Huzhou (CN); MICROVAST, INC., Stafford, TX (US)

(72) Inventors: Yang WU, Stafford, TX (US); Ningqiang XIAO, Huzhou (CN); Yun ZHAO, Huzhou (CN); Wenjuan Liu MATTIS, Stafford, TX (US)

(73) Assignees: MICROVAST POWER SYSTEMS CO., LTD., Huzhou, ZJ (CN); MICROVAST, INC., Stafford, TX (US)

(21) Appl. No.: 18/548,584

(22) PCT Filed: Mar. 2, 2021
(86) PCT No.: PCT/CN2021/078698

§ 371 Date: Sep. 1, 2023

(51) Int. Cl. H01M 50/581; H01M 50/51

(52) U.S. Cl. CPC H01M 50/581; H01M 50/51; H01M 2200/101; H01M 2220/20

(57) ABSTRACT

A battery connection structure includes a plurality of battery units connected in series. At least one battery unit is connected in series to other battery units through a temperature switch; the temperature switch includes a first connection member connected to a first electrode terminal of the battery unit and a second connection member connected to a second electrode terminal of the battery unit; at normal operating temperature, the first connection member and the second connection member are disconnected, and the first connection member and the second connection member are respectively connected to the two electrode terminals of the battery unit; when the temperature is higher than the normal operating temperature, the first connection member and/or the second connection member are/is deformed and disconnected from the corresponding electrode terminal(s) of the battery unit, and the first connection member and the second connection member are connected.

### TECHNICAL FIELD

The present application relates to the technical field of battery technology, and in particular, to a battery connection structure, a battery system, and an electric vehicle.

### BACKGROUND

With the application and widespread promotion of electric vehicles, batteries, as the core components of electric vehicles, have put forward higher requirements for the safety performance of batteries.

A battery module typically consists of multiple battery cells connected together in series or parallel. When a certain battery cell in the battery module experiences thermal runaway, it can spread to other surrounding battery cells, causing the battery pack to catch fire, explode, and other phenomena. Therefore, when designing battery modules or battery packs, it is necessary to fully consider measures to prevent thermal runaway of the battery.

### Technical Problem

Usually, there are three ways to prevent thermal runaway of batteries: 1. Add an insulation and flame retardant layer on the cover plate of the battery box; 2. Add an insulation and flame retardant layer on the battery module; 3. Add an insulation and flame retardant layer between the battery cells. The above three measures to prevent battery thermal runaway are all passive measures to prevent the thermal spread of the battery, rather than actively disconnecting the battery, cell that has experienced thermal runaway from the circuit in order to completely block the spread of thermal runaway.

In existing technologies, there are also designs that use temperature anomaly warning or circuit disconnecting, such as using a memory metal spring structure. When the battery temperature exceeds the normal operating temperature range, the circuit is disconnected by deformation of the memory metal to avoid further thermal runaway. However, this solution only considers issues regarding safety precaution and control. If a battery or battery pack experiences thermal runaway and forms an open circuit, the entire battery system cannot continue to work.

### Technical Solution

The object of the present application is to provide a battery connection structure, a battery system, and an electric vehicle, aiming to address the shortcomings of the background mentioned above. When a certain battery unit in the battery system experiences thermal runaway, a first connection member and/or a second connection member are/is deformed and disconnected from the corresponding electrode terminal(s) of the battery unit, thereby disconnecting the battery unit under thermal runaway from the circuit and completely blocking the spread of thermal runaway in a way that the entire battery system can continue to work, thereby greatly improving the safety and practicality of the battery system.

An embodiment of the present application provides a battery connection structure including multiple battery units connected in series, wherein at least one battery unit is connected in series with other battery units through a temperature switch, the temperature switch includes a first connection member connected to a first electrode terminal of the battery unit and a second connection member connected to a second electrode terminal of the battery unit;
at normal operating temperature, the first connection member and the second connection member are disconnected from each other, and the first connection member and the second connection member are respectively connected to the two electrode terminals of the battery unit to achieve battery series connection;
when the temperature is higher than the normal operating temperature, the first connection member and/or the second connection member are/is deformed and disconnected from the corresponding electrode terminal(s) of the battery unit, and the first connection member and the second connection member are connected to each other.

In an achievable embodiment, the first connection member includes a first deformation part, and the second connection member includes a second deformation part;
at normal operating temperature, the first deformation part and the second deformation part are respectively connected to the two electrode terminals of the battery unit;
when the temperature is higher than the normal operating temperature, both the first deformation part and the second deformation part are deformed and disconnected from the two electrode terminals of the battery unit, respectively.

In an achievable embodiment, both the first deformation part and the second deformation part have shape memory function;
when the temperature returns to the normal operating temperature, the first deformation part and the second deformation part both return to their respective states before deformation and are respectively connected to the two electrode terminals of the battery unit.

In an achievable embodiment, the first connection member further includes a first extension part connected to the first deformation part, the first extension part extends towards the second deformation part, and the second connection member further includes a second extension part connected to the second deformation part, the second extension part extends towards the first deformation part;
at normal operating temperature, the second extension part and the first extension part are spaced from each other in an upward or downward direction;
when the temperature is higher than the normal operating temperature, the second extension part and the first extension part come into contact with each other in an upward or downward direction.

In an achievable embodiment, the second extension part has shape memory function;
when the temperature is higher than the normal operating temperature, the second extension part is deformed in a direction towards the first extension part to be in contact with the first extension part;
when the temperature returns to the normal operating temperature, the second extension part is deformed in a direction away from the first extension part to be disconnected from the first extension part.

In an achievable embodiment, the multiple battery units include a first battery unit, a second battery unit, and a third battery unit, wherein the second battery unit is located between the first battery unit and the third battery unit, the second battery unit is connected in series with the first battery unit and the third battery unit through the temperature switch;
at normal operating temperature, the first deformation part is connected to the first electrode terminal of the second battery unit, and the second deformation part is connected to the second electrode terminal of the second battery unit;
when the temperature is higher than the normal operating temperature, the first deformation part is deformed and disconnected from the first electrode terminal of the second battery unit, and the second deformation part is deformed and disconnected from the second electrode terminal of the second battery unit.

In an achievable embodiment, the first connection member further includes a first fixing part connected to the first deformation part, the first fixing part extends towards the first battery unit, and the first fixing part is fixedly connected to a second electrode terminal of the first battery unit; the second connection member further includes a second fixing part connected to the second deformation part, the second fixing part extends towards the third battery unit, and the second fixing part is fixedly connected to a first electrode terminal of the third battery unit.

In an achievable embodiment, both the first connection member and the second connection member are in an overall “L” shaped structure.

In an achievable embodiment, the first deformation part, the first extension part and the first fixing part are in the same plane; the second deformation part and the second fixing part are both in the same plane, and the second extension part is higher than the plane in which the second deformation part and the second fixing part are located.

In an achievable embodiment, the first electrode terminal is one of the positive and negative electrode terminals of the battery unit, and the second electrode terminal is the other electrode terminal of the positive and negative electrodes of the battery unit.

In an achievable embodiment, the materials of the first deformation part and the second deformation part are memory metal or bimetallic sheets.

In an achievable embodiment, the deformation temperature of the temperature switch is between 60° C. and 150° C.

In an achievable embodiment, each battery unit is a single battery cell, or a battery pack, or a battery module.

Another embodiment of the present application also provides a battery system including the battery connection structure described above.

A further embodiment of the present application also provides an electric vehicle including the battery system described above.

### BENEFICIAL EFFECTS

In the battery connection structure provided in the present application, when the battery unit is in the normal operating temperature range, the temperature of the temperature switch is lower than the deformation temperature, the first connection member is connected to the first electrode terminal of the battery unit, the second connection member is connected to the second electrode terminal of the battery unit, the first connection member and the second connection member are disconnected from each other, and the battery unit operates normally. When the battery unit experiences thermal runaway and the temperature of the battery unit is higher than the normal operating temperature range, the temperature of the temperature switch reaches the deformation temperature, the first connection member and/or the second connection member are/is deformed and disconnected from the corresponding electrode terminal(s) of the battery unit, thereby causing the battery unit under thermal runaway to be disconnected from the circuit, and meanwhile, the first connection member and the second connection member are connected to each other, so that the entire battery system can continue to work.

The battery connection structure provided in the present application, when a certain battery unit in the battery system experiences thermal runaway, can disconnect the battery unit under thermal runaway from the circuit to completely block the spread of thermal runaway, and meanwhile the entire battery system can continue to work, thereby greatly improving the safety and practicality of the battery system.

### BRIEF DESCRIPTION OF THE DRAWINGS

FIG. 1 is a schematic diagram of the three-dimensional structure of the battery units in the embodiment of the present application.

FIG. 2 is a schematic diagram of the three-dimensional structure of the battery connection structure before deformation of the first and second connection members in the embodiment of the present application.

FIG. 3 is a side view of FIG. 2.

FIG. 4 is a schematic diagram of the three-dimensional structure of the battery connection structure after deformation of the first and second connection members in the embodiment of the present application.

FIG. 5 is a side view of FIG. 4.

FIG. 6 is a structural schematic diagram of the first connection member in FIG. 2 before deformation.

FIG. 7 is a structural schematic diagram of the first connection member in FIG. 4 after deformation.

FIG. 8 is a structural schematic diagram of the second connection member in FIG. 2 before deformation.

FIG. 9 is a structural schematic diagram of the second connection member in FIG. 4 after deformation.

FIG. 10a is a structural schematic diagram of the temperature switch in the embodiment of the present application at the normal operating temperature.

FIG. 10b is a structural schematic diagram of the temperature switch in the embodiment of the present application when the temperature is higher than the normal operating temperature.

### DETAILED DESCRIPTION OF THE EMBODIMENTS

The following will provide a further detailed description of the specific implementations of the present application in conjunction with the accompanying drawings and embodiments. The following embodiments are used to illustrate the present application, but are not intended to limit the scope of the present application.

The terms “first”, “second”, “third”, “fourth”, etc. (if any) in the specification and claims of the present application are only used to distinguish similar objects, and are not intended to be used to describe a specific sequence or order.

The terms “up”, “down.”, “left”, “right”. “front”, “back”, “top”, “bottom” any) mentioned in the specification and claims of the present application are defined based on the position of the structure in the figures and the position between the structures in the figures, only for the clarity and convenience of expressing the technical solution. It should be understood that the use of these directional words should not limit the scope of protection in the present application.

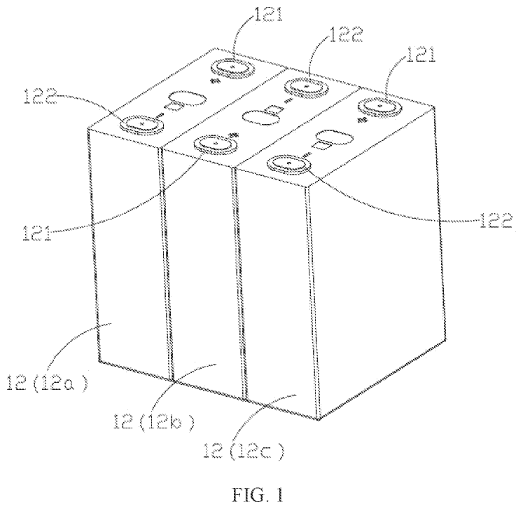

As shown from FIG. 1 to FIG. 5, an embodiment of the present application provides a battery connection structure including multiple battery units 12 connected in series, wherein each battery unit 12 is provided with a first electrode terminal 121 and a second electrode terminal 122. At least one battery unit 12 is connected in series with other battery units 12 through a temperature switch TS, wherein the temperature switch TS includes a first connection member 2 connected to the first electrode terminal 121 of the battery unit 12 and a second connection member 3 connected to the second electrode terminal 122 of the battery unit 12.

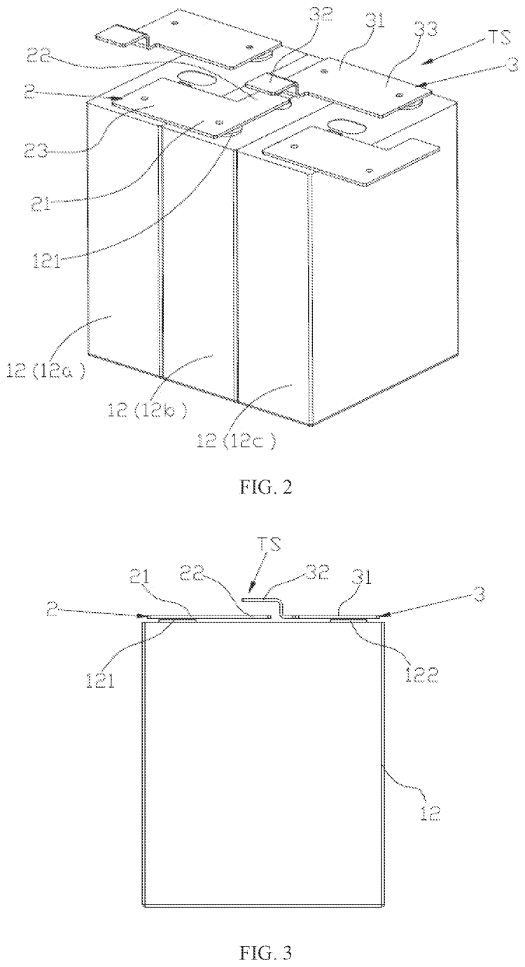

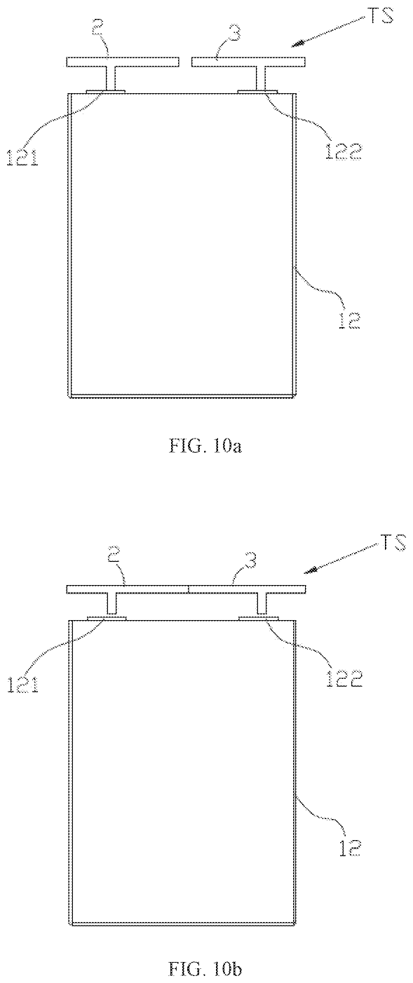

As shown from FIG. 2, FIG. 3, and FIG. 10a, at normal operating temperature, the first connection member 2 and the second connection member 3 are disconnected from each other, and the first connection member 2 and the second connection member 3 are respectively connected to the two electrode terminals (121, 122) of the battery unit 12 to achieve battery series connection.

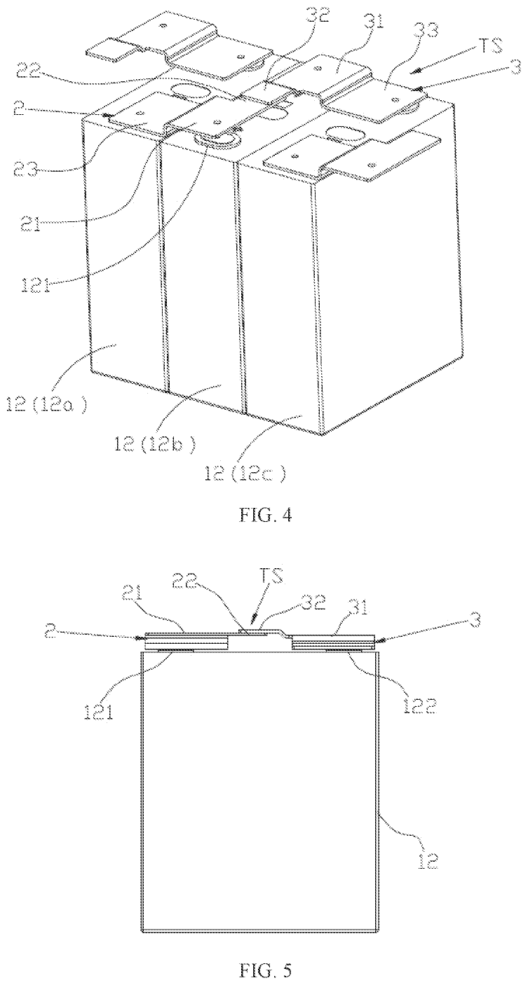

As shown from FIG. 4, FIG. 5, and FIG. 10b, when the temperature is higher than the normal operating temperature, the first connection member 2 and/or the second connection member 3 are/is deformed and disconnected from the corresponding electrode terminals) of the battery unit 12, and meanwhile, the first connection member 2 and the second connection member 3 are connected to each other. At this time, the battery unit 12 is disconnected from the circuit, and the entire circuit can continue to work.

Specifically, each battery unit 12 can be a single battery cell, a battery pack, or a battery module, and the battery connection structure can be provided inside a battery cell, a battery pack or a battery module, or in a connection structure outside a battery. The first electrode terminal 121 is one of the positive and negative electrode terminals of the battery unit 12, and the second electrode terminal 122 is the other electrode terminal of the positive and negative electrodes of the battery unit 12. In this embodiment, the first connection member 2 and the second connection member 3 are both thin sheet shaped connection plates. Of course, in other embodiments, the first connection member 2 and the second connection member 3 can also be of other shapes and structures, and are not limited here.

As shown from FIG. 4 and FIG. 5, when the battery unit 12 is in a high-temperature working state or when the battery cell experiences thermal runaway causing temperature abnormalities, due to the excellent thermal conductivity of the electrode terminals (or tabs, battery poles) of the battery unit 12, the heat of the battery unit 12 can be quickly transmitted to temperature switch TS, and at this time, the temperature of the temperature switch TS reaches the deformation temperature, the first connection member 2 and the second connection member 3 are deformed under the action of internal force due to shape deformation, such that the first connection member 2 and the second connection member 3 are disconnected from the corresponding electrode terminals 121/122 of the battery unit 12, causing the battery unit 12 to be disconnected from the circuit. Meanwhile, the first connection member 2 and the second connection member 3 are connected to each other, and the entire circuit can continue to work. As shown from FIG. 2 and FIG. 3, after a period of cooling, the temperature of the battery unit 12 returns to the normal operating temperature range, and the temperature of the temperature switch TS returns to below the deformation temperature, the first connection member 2 and the second connection member 3 return to their respective states before deformation and are connected to the corresponding electrode terminals 121/122 of the battery unit 12, and meanwhile, the first connection member 2 and the second connection member 3 return to the state of being disconnected from each other, causing the battery unit 12 to be re-connected to the circuit, so that the battery system returns to normal working state.

In an embodiment, both the first connection member 2 and the second connection member 3 have shape memory function. When the temperature is higher than the normal operating temperature, both the first connection member 2 and the second connection member 3 are deformed and disconnected from the first electrode terminal 121 and the second electrode terminal 122 of the battery unit 12, respectively, and meanwhile, the first connection member 2 comes into contact with the second connection member 3. When the temperature returns to the normal operating temperature, both the first connection member 2 and the second connection member 3 return to their respective states before deformation and come into contact with the first electrode terminal 121 and the second electrode terminal 122 of the battery unit 12, respectively, and meanwhile, the first connection member 2 and the second connection member 3 return to the state of being disconnected from each other.

Of course, in other embodiments, only one of the first connection member 2 and the second connection member 3 may have shape memory, function, while the other may not. For example, the first connection member 2 has shape memory function, while the second connection member 3 does not. When the temperature is higher than the normal operating temperature, the first connection member 2 is deformed and disconnected from the first electrode terminal 121 of the battery unit 12, while the shape of the second connection member 3 remains unchanged, and the deformed first connection member 2 comes into contact with the second connection member 3. This structure with only one connection member 2/3 having shape memory function can also cause the battery unit 12 to be disconnected from the circuit, and the entire circuit can continue to work.

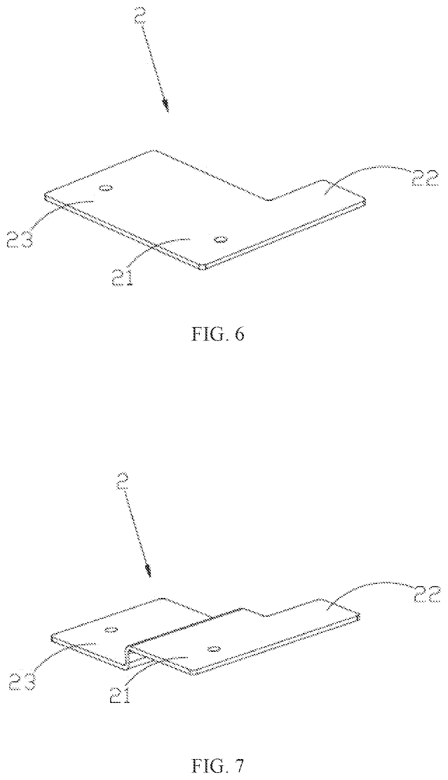

In an embodiment, as shown from FIG. 6 to FIG. 9, the first connection member 2 includes a first deformation part 21, and the second connection member 3 includes a second deformation part 31. As shown from FIG. 2 and FIG. 3, at normal operating temperature, the first deformation part 21 and the second deformation part 31 are respectively connected to the two electrode terminals (121, 122) of the battery unit 12. As shown from FIG. 4 and FIG. 5, when the temperature is higher than the normal operating temperature, both the first deformation part 21 and the second deformation part 31 are deformed and disconnected from the two electrode terminals (121, 122) of the battery unit 12, respectively.

In an embodiment, both the first deformation part 21 and the second deformation part 31 have shape memory function. When the temperature returns to the normal operating temperature, the first deformation part 21 and the second deformation part 31 both return to their respective states before deformation and are connected to the two electrode terminals (121, 122) of the battery unit 12, respectively.

In an embodiment, as shown from FIG. 6 to FIG. 9, the first connection member 2 further includes a first extension part 22 connected to the first deformation part 21, and the first extension part 22 extends towards the second deformation part 31. The second connection member 3 further includes a second extension part 32 connected to the second deformation part 31, and the second extension part 32 extends towards the first deformation part 21. As shown from FIG. 2 and FIG. 3, at normal operating temperature, the second extension part 32 and the first extension part 22 are spaced from each other in an upward or downward direction; as shown from FIG. 4 and FIG. 5, when the temperature is higher than the normal operating temperature, the second extension part 32 and the first extension part 22 come into contact with each other in an upward or downward direction.

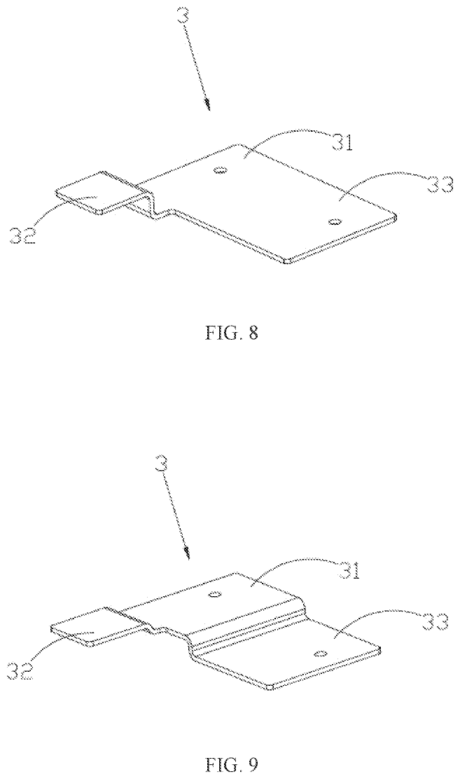

In one embodiment, as shown from FIG. 8 and FIG. 9, the second extension part 32 also has shape memory function. Please refer to MG. 4, FIG. 5, and FIG. 9, when the temperature is higher than the normal operating temperature, the second extension part 32 is deformed in a direction towards the first extension part 22. Please refer to FIG. 2, FIG. 3, and FIG. 8, when the temperature returns to the normal operating temperature, the second extension part 32 is deformed in a direction away from the first extension part 22 and returns to its state before deformation. By setting the second extension part 32 to have shape memory function, it is ensured that when the temperature is higher than the normal operating temperature, the second extension part 32 will come into contact with the first extension part 22, and when the temperature returns to the normal operating temperature, the second extension part 32 will be separated from the first extension part 22, thereby achieving the connection and disconnection between the first connection member 2 and the second connection member 3.

Specifically, please refer to FIG. 4, FIG. 7, and FIG. 9, when the temperature is higher than the normal operating temperature, both the first deformation part 21 and the second deformation part 31 are deformed to move upwards (the directional words “up” and “down” here are only for convenience of description and do not constitute a limitation in this application), which at the same time drives the first extension part 22 and the second extension part 32 to move upwards, thereby causing the first deformation part 21 and the second deformation part 31 to be disconnected from the first electrode terminal 121 and the second electrode terminal 122 of the battery unit 12, respectively, and meanwhile, the second extension part 32 is deformed to move downwards, so as to ensure that the second extension part 32 comes into contact with the first extension part 22. Please refer to FIG. 2, FIG. 6, and FIG. 8, when the temperature returns to the normal operating temperature, both the first deformation part 21 and the second deformation part 31 are deformed to move downwards, and also drive the first extension part 22 and the second extension part 32 to move downwards, thereby causing the first deformation part 21 and the second deformation part 31 to come into contact with the first electrode terminal 121 and the second electrode terminal 122 of the battery unit 12, respectively, and meanwhile, the second extension part 32 is deformed to move upwards, so as to ensure that the second extension part 32 is separated from the first extension part 22.

In an embodiment, as shown from FIG. 1 to FIG. 5, the multiple battery units 12 include a first battery unit 12a, a second battery unit 12b, and a third battery unit 12c. The second battery unit 12b is located between the first battery unit 12a and the third battery unit 12c, and the second battery unit 12b is connected in series with the first battery unit 12a and the third battery unit 12c through a temperature switch TS.

When the second battery unit 12b is at normal operating temperature, the first deformation part 21 is connected to the first electrode terminal 121 of the second battery unit 12b, and the second deformation part 31 is connected to the second electrode terminal 122 of the second battery unit 12b.

When the temperature of the second battery unit 12b is higher than the normal operating temperature, the first deformation part 21 is deformed and disconnected from the first electrode terminal 121 of the second battery unit 12b, and the second deformation part 31 is deformed and disconnected from the second electrode terminal 122 of the second battery unit 12b.

In an embodiment, the first connection member 2 further includes a first fixing part 23 connected to the first deformation part 21, the first fixing part 23 extends towards the first battery unit 12a, and the first fixing part 23 is fixedly connected to the second electrode terminal 122 of the first battery unit 12a. The second connection member 3 further includes a second fixing part 33 connected to the second deformation part 31, the second fixing part 33 extends towards the third battery unit 12c, and the second fixing part 33 is fixedly connected to the first electrode terminal 121 of the third battery unit 12c.

In an embodiment, both the first connection member 2 and the second connection member 3 are in an overall “L” shaped structure.

In an embodiment, as shown from FIG. 6 and FIG. 8, the first deformation part 21, the first extension part 22 and the first fixing part 23 are all in the same plane. The second deformation part 31 and the second fixing part 33 are both in the same plane, and the second extension part 32 is higher than the plane in which the second deformation part 31 and the second fixing part 33 are located.

In an embodiment, the materials of the first deformation part 21, the second deformation part 31 and the second extension part 32 are memory metal or bimetallic sheets.

In an embodiment, the materials of the first deformation part 21, the second deformation part 31 and the second extension part 32 can be copper aluminum nickel alloy, copper nickel alloy, titanium nickel alloy, or copper zinc alloy, etc.

In an embodiment, the deformation temperature of the temperature switch TS (including the first deformation part 21, the second deformation part 31 and the second extension part 32) can be designed based on the working temperature of the battery unit 12, for example, the deformation temperature of the temperature switch TS can be between 60° C. and 150° C.

In another embodiment, the deformation temperature of the temperature switch TS is between 80° C. and 130° C.

In another embodiment, the deformation temperature of the temperature switch TS is between 100° C. and 120° C.

Another embodiment of the present application provides a battery system, including the battery connection structure described above.

Another embodiment of the present application provides an electric vehicle, including the battery system described above.

In the battery connection structure provided in the embodiments of the present application, when the battery unit 12 is in the normal operating temperature range, the temperature of the temperature switch TS is lower than the deformation temperature, the first connection member 2 is connected to the first electrode terminal 121 of the battery unit 12, the second connection member 3 is connected to the second electrode terminal 122 of the battery unit 12, the first connection member 2 and the second connection member 3 are disconnected from each other, and the battery unit 12 operates normally. When the battery unit 12 experiences thermal runaway and the temperature of the battery unit 12 is higher than the normal operating temperature range, the temperature of the temperature switch IS reaches the deformation temperature, the first connection member 2 and/or the second connection member 3 are deformed and disconnected from the corresponding electrode terminal(s) 121/122 of the battery unit 12, thereby causing the battery unit 12 under thermal runaway to be disconnected from the circuit, and meanwhile, the first connection member 2 and the second connection member 3 are connected to each other, so that the entire battery system can continue to work.

The battery connection structure provided in the embodiments of the present application, when a certain battery unit in the battery system experiences thermal runaway, by utilizing the shape memory function of the temperature switch, can disconnect the battery unit under thermal runaway from the circuit to completely block the spread of thermal runaway, and meanwhile the entire battery system can continue to work, thereby greatly improving the safety and practicality of the battery system.

The above are only the specific embodiments of the present application, but the scope of protection of the present application is not limited to this. Any technical personnel familiar with this technical field who can easily think of changes or replacements within the scope of technology disclosed in the present application should be covered within the scope of protection of the present application. Therefore, the protection scope of the present application should be based on the protection scope of the claims.

### INDUSTRIAL APPLICABILITY

In the battery connection structure provided in the present application, when the battery unit is in the normal operating temperature range, the temperature of the temperature switch is lower than the deformation temperature, the first connection member is connected to the first electrode terminal of the battery unit, the second connection member is connected to the second electrode terminal of the battery unit, the first connection member and the second connection member are disconnected from each other, and the battery unit operates normally. When the battery unit experiences thermal runaway and the temperature of the battery unit is higher than the normal operating temperature range, the temperature of the temperature switch reaches the deformation temperature, the first connection member and/or the second connection member are/is deformed and disconnected from the corresponding electrode terminal(s) of the battery unit, thereby causing the battery unit under thermal runaway to be disconnected from the circuit, and meanwhile, the first connection member and the second connection member are connected to each other, so that the entire battery system can continue to work.

The battery connection structure provided in the present application, when a certain battery unit in the battery system experiences thermal runaway, can disconnect the battery unit under thermal runaway from the circuit to completely block the spread of thermal runaway, and meanwhile the entire battery system can continue to work, thereby greatly improving the safety and practicality of the battery system.

1. A battery connection structure, comprising multiple battery units connected in series, wherein at least one battery unit is connected in series with other battery units through a temperature switch, the temperature switch comprises a first connection member connected to a first electrode terminal of the battery unit and a second connection member connected to a second electrode terminal of the battery unit;
at normal operating temperature, the first connection member and the second connection member are disconnected from each other, and the first connection member and the second connection member are respectively connected to the two electrode terminals of the battery unit to achieve battery series connection;
when the temperature is higher than the normal operating temperature, the first connection member and/or the second connection member are/is deformed and disconnected from the corresponding electrode terminal of the battery unit, and the first connection member and the second connection member are connected to each other.

2. The battery connection structure as claimed in claim 1, wherein the first connection member comprises a first deformation part, and the second connection member comprises a second deformation part;
at normal operating temperature, the first deformation part and the second deformation part are respectively connected to the two electrode terminals of the battery unit;
when the temperature is higher than the normal operating temperature, both the first deformation part and the second deformation part are deformed and disconnected from the two electrode terminals of the battery unit, respectively.

3. The battery connection structure as claimed in claim 2, wherein both the first deformation part and the second deformation part have shape memory function;
when the temperature returns to the normal operating temperature, the first deformation part and the second deformation part both return to their respective states before deformation and are respectively connected to the two electrode terminals of the battery unit.

4. The battery connection structure as claimed in claim 2, wherein the first connection member further comprises a first extension part connected to the first deformation part, the first extension part extends towards the second deformation part, and the second connection member further comprises a second extension part connected to the second deformation part, the second extension part extends towards the first deformation part;
at normal operating temperature, the second extension part and the first extension part are spaced from each other in an upward or downward direction;
when the temperature is higher than the normal operating temperature, the second extension part and the first extension part come into contact with each other in an upward or downward direction.

5. The battery connection structure as claimed in claim 4, wherein the second extension part has shape memory function;
when the temperature is higher than the normal operating temperature, the second extension part is deformed in a direction towards the first extension part to be in contact with the first extension part;
when the temperature returns to the normal operating temperature, the second extension part is deformed in a direction away from the first extension part to be disconnected from the first extension part.

6. The battery connection structure as claimed in claim 2, wherein the multiple battery units comprise a first battery unit, a second battery unit, and a third battery unit, wherein the second battery unit is located between the first battery unit and the third battery unit, the second battery unit is connected in series with the first battery unit and the third battery unit through the temperature switch;
at normal operating temperature, the first deformation part is connected to the first electrode terminal of the second battery unit, and the second deformation part is connected to the second electrode terminal of the second battery unit;
when the temperature is higher than the normal operating temperature, the first deformation part is deformed and disconnected from the first electrode terminal of the second battery unit, and the second deformation part is deformed and disconnected from the second electrode terminal of the second battery unit.

7. The battery connection structure as claimed in claim 6, wherein the first connection member further comprises a first fixing part connected to the first deformation part, the first fixing part extends towards the first battery unit, and the first fixing part is fixedly connected to a second electrode terminal of the first battery unit; the second connection member further comprises a second fixing part connected to the second deformation part, the second fixing part extends towards the third battery unit, and the second fixing part is fixedly connected to a first electrode terminal of the third battery unit.

8. The battery connection structure as claimed in claim 7, wherein both the first connection member and the second connection member are in an overall “L” shaped structure.

9. The battery connection structure as claimed in claim 8, wherein at normal operating temperature, the first deformation part, the first extension part and the first fixing part are in the same plane; at normal operating temperature, the second deformation part and the second fixing part are both in the same plane, and the second extension part is higher than the plane in which the second deformation part and the second fixing part are located.

10. The battery connection structure as claimed in claim 2, wherein the materials of the first deformation part and the second deformation part are memory metal or bimetallic sheets.

11. The battery connection structure as claimed in claim 1, wherein the deformation temperature of the temperature switch is between 60° C. and 150° C.

12. A battery system, comprising the battery connection structure as claimed in claim 1.

13. An electric vehicle, comprising the battery system as claimed in claim 12.

14. The battery connection structure as claimed in claim 1, wherein the deformation temperature of the temperature switch is between 80° C. and 130° C.

15. The battery connection structure as claimed in claim 3, wherein the materials of the first deformation part and the second deformation part are memory metal or bimetallic sheets.

16. The battery connection structure as claimed in claim 4, wherein the materials of the first deformation part and the second deformation part are memory metal or bimetallic sheets.

17. The battery connection structure as claimed in claim 5, wherein the materials of the first deformation part and the second deformation part are memory metal or bimetallic sheets.

18. The battery connection structure as claimed in claim 6, wherein the materials of the first deformation part and the second deformation part are memory metal or bimetallic sheets.

19. The battery connection structure as claimed in claim 7, wherein the materials of the first deformation part and the second deformation part are memory metal or bimetallic sheets.

20. The battery connection structure as claimed in claim 1, wherein at normal operating temperature, the first connection member and the second connection member are horizontally spaced apart from each other;
when the temperature is higher than the normal operating temperature, the first connection member and the second connection member approach horizontally toward each other and come into contact with each other.
